(19) United States
(12) Patent Application Publication
(10) Pub. No.: US 2019/0232418 A1
(43) Pub. Date: Aug. 1, 2019

(54) PLASMA CUTTING TOOL

(71) Applicant: Carmen J Fedele, Tidioute, PA (US)

(72) Inventor: Carmen J Fedele, Tidioute, PA (US)

(21) Appl. No.: 16/198,739

(22) Filed: Nov. 21, 2018

Related U.S. Application Data
(60) Provisional application No. 62/590,042, filed on Nov. 22, 2017.

(51) Int. Cl. B23K 10/00; B23K 37/047; B23K 37/02

(52) U.S. Cl. CPC B23K 10/00; B23K 37/0288; B23K 37/027; B23K 37/047

(57) ABSTRACT

A hole cutting system and device for a plasma torch. The system employs a two element guide member which ensures stability during the cutting process while virtually eliminating deviation from the desired circle radius. A hold down plate is used to secure the device in position. An adjustable torch cup holder is pivotally attached to a rotatable inner member. A stationary annular outer member is attached to the hold down plate and includes a plurality of hold down clips for securing a workpiece. An annular recess is formed in the outer member and is sized for slidingly engaging the rotatable inner member so that the annular outer member functions as a guide for the inner member. The diameter of the hole to be cut in the workpiece is controlled by adjusting the angular position of the torch cup holder. A plurality of circumferentially spaced handles are attached to the inner member and extend exteriorly of the outer member so that grasping and rotating the handles causes rotation of the inner member to effect cutting of the workpiece when an active welding torch cup is positioned in the torch cup holder.

### CROSS REFERENCE TO RELATED APPLICATION

This application claims priority from U.S. Provisional Application 62/590,042 filed Nov. 22, 2017.

### BACKGROUND OF THE INVENTION

The present invention relates generally to plasma torch cutting tools. More specifically, the invention relates to an improved plasma torch cutting tool which allows for cutting holes in metal sheets.

### Statement of the Prior Art

Hole cutting tools for plasma cutters are known in the art. The construction of these devices varies but generally include some sort of pivotable or angularly adjustable mechanism, a mechanized rotating element, and a torch cup holder attached in some way to the adjustable mechanism.

Typical of these devices is that disclosed in U.S. Pat. No. 5,511,765 issued to one Shippen for a hole cutting apparatus is typical. An axis of rotation is fixed by a center locating member, and the radius is adjusted by a linearly reciprocal torch cup holder. Like many of these devices, if the center locating member is displaced, the hole will not be circular.

### SUMMARY OF THE INVENTION

The present invention overcomes the disadvantages of the prior art by providing a hole cutting system and device for a plasma torch. The system employs a two element guide member which ensures stability during the cutting process while virtually eliminating deviation from the desired circle radius. A hold down plate is used to secure the device in position. An adjustable torch cup holder is pivotally attached to a rotatable inner member. A stationary annular outer member is attached to the hold down plate and includes a plurality of hold down clips for securing a workpiece. An annular recess is formed in the outer member and is sized for slidingly engaging the rotatable inner member so that the annular outer member functions as a guide for the inner member. The diameter of the hole to be cut in the workpiece is controlled by adjusting the angular position of the torch cup holder. A plurality of circumferentially spaced handles are attached to the inner member and extend exteriorly of the outer member so that grasping and rotating the handles causes rotation of the inner member to effect cutting of the workpiece when an active welding torch cup is positioned in the torch cup holder.

Accordingly, it is an object of the invention to provide a plasma cutting tool which allows a plasma torch to cut a circular hole in a workpiece.

It is another object of the invention to provide a plasma cutting tool which can be manually adjusted to change the diameter of the hole to be cut.

It is another object of the invention to provide a plasma cutting tool which has a slidingly engaged outer guide member.

It is another object of the invention to provide a plasma cutting tool which has an outer guide member which includes a plurality of workpiece holders.

It is another object of the invention to provide a plasma cutting tool which has a rotatable inner member which can adjustably position a plasma torch cup.

### BRIEF DESCRIPTION OF THE DRAWINGS

FIG. 1 is a perspective view of the plasma cutting tool of the invention.

FIG. 2 is a plan view of the plasma cutting tool of the invention.

FIG. 3 is a cross section of the of the plasma cutting tool of the invention detailing the interaction of inner and outer rings.

### DETAILED DESCRIPTION OF THE INVENTION

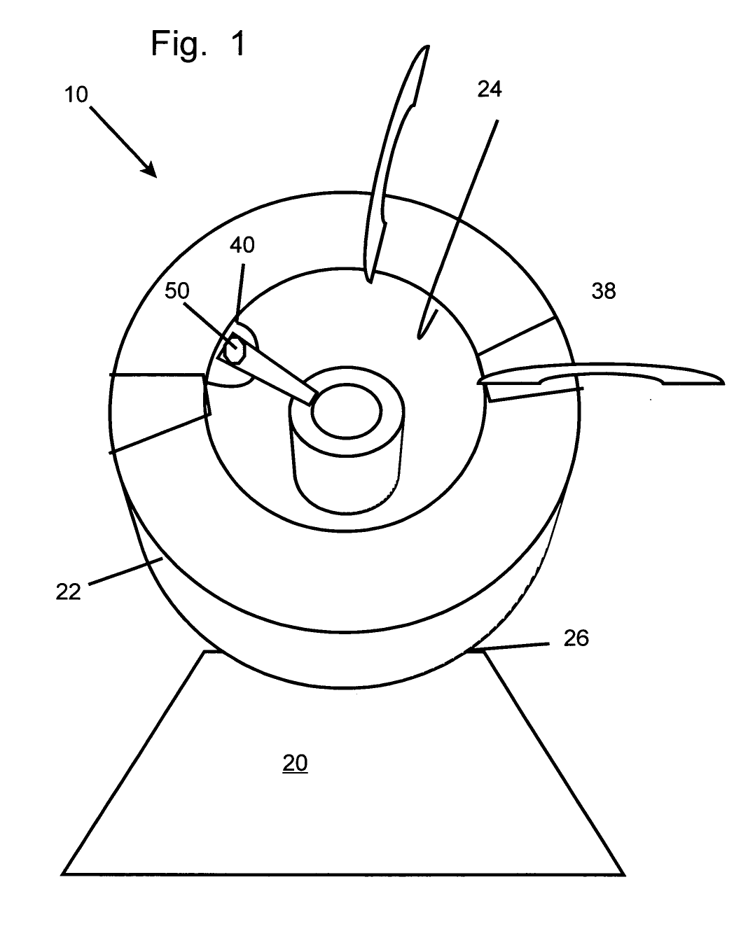

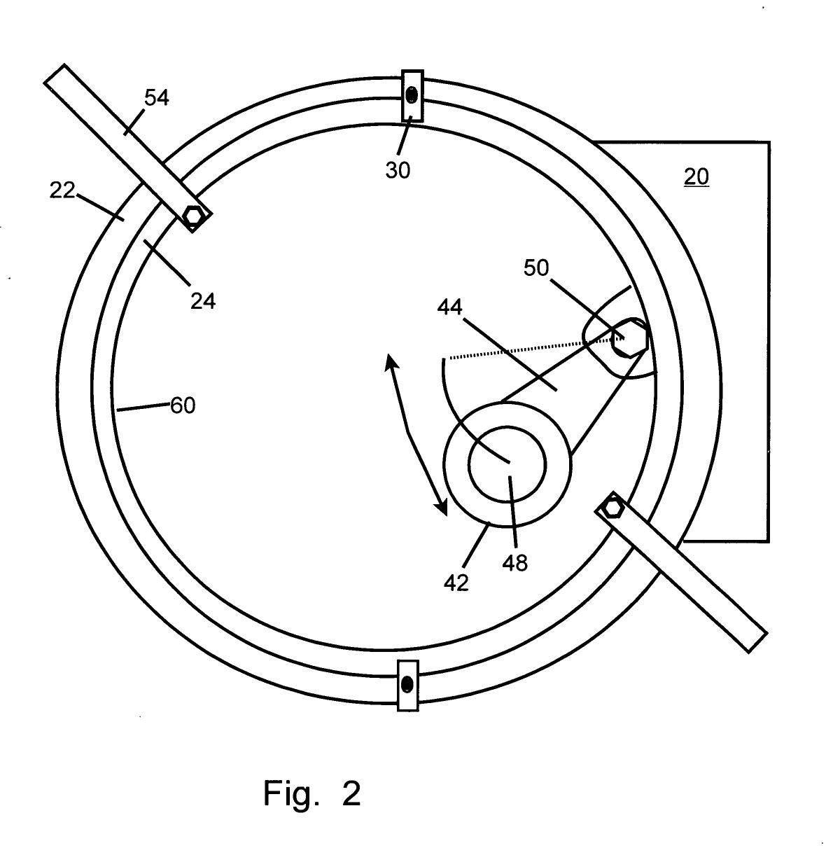

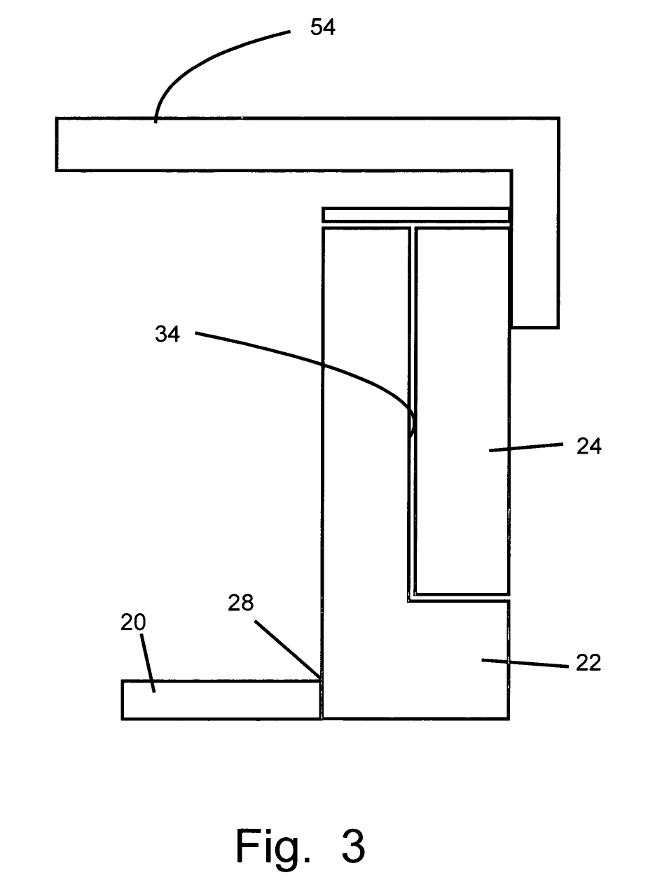

Referring now to FIGS. 1-3 the invention, generally indicated by the numeral 10 is shown. The tool 10 has three main components: a hold down plate 20, a stationary outer ring 22, and a rotating inner ring 24. The hold down plate 20 is essentially a flat plate which may have any shape provided it has an edge region 26 which can be permanently attached to a portion of the outer ring 22. The edge region 26 terminates in an outer edge 28 having an arcuate shape corresponding exactly to the portion of the outer ring 22 to which it is attached as by, e.g., welding. Thus no portion of the hold down plate 20 extends beyond the inner boundary of the outer ring 22. The hold down plate 20 may be anchored to a stationary structure or weighted down to provide additional stability during the cutting process. A weight plate 29 made out of metal or other dense flame and heat resistant material is preferably used to anchor the cutting tool 10, obviating the need for screws or other fasteners to attach the plate 20 to a stationary surface. It should be noted that the tool 10 may be oriented vertically by attaching the hold down plate 20 to a vertical surface such as a wall. The hold down plate 20 functions essentially as an anchor, but it's flat planar profile also allows it to function as a heat sink to help dissipate heat when welding. Also, positioning the hold down plate 20 so that no part of the plate 20 is within the boundary of the outer ring as discussed above limits the amount of heat received by the hold down plate 20 from the cutting torch which allow it to function more effectively as a heat sink.

The stationary outer ring 22 has an annular shape and essentially defines the outermost limit (or maximum diameter) of the hole to be cut in the workpiece. A plurality of circumferentially spaced hold down clips 30 are positioned on the underside of the outer ring 22 and are configured to clamp onto the workpiece. The clips 30 may be configured to frictionally engage the workpiece and are preferably adjustably tightened onto the workpiece. A portion of the outer ring 22 is recessed to form a track 34 within which the inner ring 24 is slidably engaged. The surface of the track 34 is made as smooth as possible to facilitate turning of the inner ring 24 and may optionally be lubricated.

The inner ring 24 is seated within track 34 and is held in position by at least a pair of guides 38 which are fastened onto the outer ring 22 so that the inner ring 24 cannot be accidentally vertically displaced during the cutting operation. Tab 40 is attached to and extends inwardly from inner ring 24 to anchor the adjustable torch holder 42. The torch holder 42 has an arm 44 which is hingedly attached to tab 40 at one end, and terminates at the other end with cup holder 48 which is adapted to hold a standard plasma torch cup. A hex head bolt 50 or its equivalent may be used to attach arm 44 to tab 40, the bolt 50 can be loosened to adjust the angle at which the arm depends. Thus the radius of the circle to be cut in the workpiece is adjusted by loosening the bolt 50 and pivoting the cup holder 48 to the desired position. A plurality of circumferentially spaced handles 54 are securely attached to the inwardly facing surface 60 of the inner ring 24 to facilitate rotation of the ring 24.

In operation, the workpiece (not shown) to be cut is positioned as desired and then secured in position using workpiece clamps. The torch cup is then positioned within the cup holder. The inner ring 24 may then be rotated with the plasma torch turned on, effecting the hole cutting operation until a complete hole is formed in the workpiece.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. A plasma torch cutting tool comprising:
a hold down plate having an arcuate edge region;
a stationary outer ring attached to said hold down plate, said outer ring having a track formed therein, and a plurality of workpiece clamping members;
a rotatable inner ring slidably engaged within said track for rotation within said outer ring, said inner ring including at least one grasping handle for effecting rotation;
a torch cup holder pivotally attached to said inner ring and sized for holding a standard torch cup.

2. The tool of claim 1 wherein there are multiple grasping handles attached to said inner ring.

3. The tool of claim 1 wherein said hold down plate can be positioned horizontally or vertically.

4. The tool of claim 1 wherein said hold down plate is positioned to function as a heat sink.
